(19) United States
(12) Patent Application Publication
(10) Pub. No.: US 2006/0086238 A1
(43) Pub. Date: Apr. 27, 2006

(54) Apparatus and method for reproducing MIDI file

(75) Inventors: Jae Hyuck Lee, Seoul (KR); Jung Min Song, Seoul (KR); Yong Chul Park, Seoul (KR); Jun Yup Lee, Yongin-si (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/255,760

(22) Filed: Oct. 21, 2005

(30) Foreign Application Priority Data
Oct. 22, 2004 (KR) 10-2004-0084921
Oct. 22, 2004 (KR) 10-2004-0084922

(51) Int. Cl. G10H 7/00

(52) U.S. Cl. 84/645

(57) ABSTRACT

An apparatus and a method for reproducing a MIDI file are provided. In the apparatus and the method, a point that limits reproduction of a MIDI file is determined and reproduction of the MIDI file is forcibly terminated at the determined reproduction limitation point when the MIDI file is reproduced. Therefore, non-continuous points are reduced and thus noises are reduced, so that the MIDI file can be reproduced in high quality.

### BACKGROUND OF THE INVENTION

1. Field of the Invention

The present invention relates to an apparatus and a method for reproducing a MIDI-based music file.

2. Description of the Related Art

To reproduce a MIDI (musical instrument digital interface) file into a real sound, many methods can be used. Representative methods include a frequency modulation (FM) synthesis method and a wave table synthesis method. The FM synthesis method reproduces a sound by synthesizing basic waveforms. Since the FM synthesis method does not require a separate sound source, it has an advantage of using a small amount of memory but has a disadvantage of not reproducing a natural sound close to an original sound. On the contrary, the wave table synthesis method stores sound sources for each instrument and each note of each instrument in advance and synthesizes these sound sources to reproduce a sound. The wave table synthesis method has a disadvantage of using a large amount of memory in storing the sound sources, but has an advantage of reproducing a natural sound close to an original sound.

To hear a sound in real-time through a MIDI file reproducing system, a process of synthesizing a sound using a MIDI file and a sound source should be performed in real-time. A process of synthesizing a sound requires a considerable amount of processor resources. Parts that use the processor resources in the MIDI file reproducer include an envelope generator. The envelope generator is used to generate the envelope of a sound waveform determining the size of the volume or the pitch of a sound. Therefore, the envelope generator has a considerable influence on sound quality and uses a large portion of the processor resources.

Here, the envelope includes an envelope for the volume and an envelope for the pitch. Referring to FIG. 1, the envelope is divided into four steps of Attack 12, Decay 13, Sustain 17, and Release 14 after Delay 11 starting from Note-On 15. Though the envelope is expressed in a linear form in FIG. 1, it can have a liner form or a concave form depending on the kind of the envelope and the characteristic of each step. Also, articulation data, which is information representing a unique characteristic of a sound source, contains time information for the four steps of Attack 12, Decay 13, Sustain 17, Release 14 and is used in synthesizing a sound. One note is reproduced by applying the above envelope and a plurality of notes are gathered to complete one musical piece.

When one note is reproduced by applying the envelope of FIG. 1, the envelope after Note-Off 16 should reduce and fall down until the envelope becomes zero so as to reproduce the note in the most ideal manner. However, since a reproducing apparatus (e.g., a mobile terminal) having limited resources cannot reproduce a note in this manner, development of a new technology is required.

FIG. 2 is a view of an apparatus for reproducing a MIDI file. The apparatus includes: a MIDI parser 21 for extracting a plurality of notes and note reproduction times from a MIDI file; a MIDI sequencer 22 for sequentially outputting the extracted note reproduction times; a wave table 24 for registering at least one sound source sample; and a frequency converter 23 for frequency-converting at least one registered sound sample into sound source samples that correspond to respective notes whenever the note reproduction time is outputted

The MIDI file inputted to the MIDI parser 21 contains information regarding predetermined music stored in advance in a storage medium thereof. The MIDI file can include a plurality of notes and note reproduction times. A note is information representing a sound. For example, the note represents information (e.g., Do, Re, and Mi) regarding a musical scale. Since the note is not a real sound, it should be reproduced into actual sound sources. Also, the note reproduction time means a reproduction time of each of the notes contained in the MIDI file and is information regarding the same length of a sound. For example, when the reproduction time of a note “Re” is ⅛ second, a sound source that corresponds to the note “Re” is reproduced for ⅛ second when it is reproduced.

Sound sources for each instrument and each note of each instrument are registered in the wave table 24. A musical scale includes 1 to 128. There is a limitation in registering all of sound sources for the musical scale (i.e., notes contained therein) in the wave table 24. Therefore, sound source samples for only several representative notes are registered in the wave table 24.

When the reproduction time for the note is inputted, the frequency converter 23 judges whether a sound source for the relevant note is present in the wave table 24 and frequency-converts the note into a sound source that correspond to the relevant note. The frequency converter 23 may be an oscillator.

In the case where a sound source for the relevant note is not present in the wave table 24, the frequency converter 23 reads a predetermined sound source sample from the wave table 24 and frequency-converts the read sound source sample into a sound source sample that corresponds to the relevant note. In the case where a sound source for the relevant note is present in the wave table 24, the frequency converter 23 reads the relevant sound source sample from the wave table 24 and outputting the same without a separate frequency conversion. For example, in the case where a sound source sample registered in the wave table 24 is sampled by 20 kHz and a note of desired music is sampled by 40 kHz, the sound source sample is finally frequency-converted into 40 kHz and reproduced. That is, the sound source sample of 20 kHz can be frequency-converted and outputted into a sound source sample of 40 kHz by the frequency converter 23.

The above processes are repeatedly performed whenever the note reproduction time for each note is inputted. However, in the case where the frequency conversion is repeatedly performed whenever the note reproduction time for each note is inputted as described above, a considerable amount of operations is required, so that the relevant processor can be overloaded. Moreover, the relevant MIDI file should be reproduced and outputted in real-time. However, since the frequency conversion is performed for each note as described above, music may not be reproduced in real-time. In short, the MIDI reproducing apparatus can reproduce music substantially only in the case where it uses a considerable amount of processor resources.

### SUMMARY OF THE INVENTION

Accordingly, the present invention is directed to an apparatus and a method for reproducing a MIDI file that substantially obviate one or more problems due to limitations and disadvantages of the related art.

An object of the present invention is to provide an apparatus and a method for reproducing a MIDI file, capable of reducing non-continuous points and noises thereof to allow the MIDI file to be reproduced in high quality by determining a time point that limits reproducing of the MIDI file and forcibly terminating the reproducing of the MIDI file at the determined reproduction limitation point when the MIDI file is reproduced.

Another object of the present invention is to provide an apparatus and a method for reproducing a MIDI file, capable of guaranteeing a high quality sound while using limited processor resources by determining a time point that limits reproducing of the MIDI file and finding out a zero crossing point to forcibly terminate the reproducing of the MIDI file at the zero crossing point when the MIDI file is reproduced.

A further another object of the present invention is to provide an apparatus and a method for reproducing a MIDI file, capable of guaranteeing a high quality sound while using limited processor resources by determining a time point that limits reproducing of the MIDI file and controlling a slope of an envelope to forcibly terminate the reproducing of the MIDI file at the determined reproduction limitation point when the MIDI file is reproduced.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for reproducing a MIDI file including: extracting a plurality of notes and note reproduction times from the MIDI file; searching a point where envelope values of sound source samples after Note-Off are close to zero; determining the searched point as a point that limits a sound source sample value; and reflecting the determined limitation point to output the sound source samples according to the note reproduction times.

In the second aspect of the present invention, there is provided a method for reproducing a MIDI file including: extracting a plurality of notes and note reproduction times from the MIDI file; calculating envelope slopes of sound source samples after Note-Off; and applying the calculated envelope slopes to output the sound source samples according to the note reproduction times.

In the third aspect of the present invention, there is provided an apparatus for reproducing a MIDI file including: an element for extracting a plurality of notes and note reproduction times from the MIDI file; an element for finding out points where envelope values of sound source samples after Note-Off are close to zero; an element for determining the found points as points that limit the sound source samples; and an element for reflecting the determined limitation points to output the relevant sound samples according to the note reproduction times.

In the fourth aspect of the present invention, there is provided an apparatus for reproducing a MIDI file including: an element for extracting a plurality of notes and note reproduction times from the MIDI file; an element for calculating envelope slopes of sound source samples after Note-Off; and outputting the sound source samples according to the note reproduction times on the basis of the calculated envelope slopes

According to the present invention, it is possible to reduce a time consumed until the envelope value falls down to zero while minimizing noises heard to a human ear. Therefore, overload of a CPU is prevented, reproduction of high quality MIDI music can be performed by a CPU of low specification, and deterioration of sound quality can be prevented.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating an envelope when a MIDI file is reproduced;

FIG. 2 is a view of an apparatus for reproducing a MIDI file;

FIGS. 3 and 4 are views illustrating envelope values of sound samples are limited according to the present invention:

FIG. 5 is a view of an apparatus for reproducing a MIDI file according to an embodiment of the present invention;

FIG. 6 is a view illustrating an envelope when a MIDI file is reproduced according to the present invention; and

FIG. 7 is a view of an apparatus for reproducing a MIDI file according to an embodiment of the present invention.

### DETAILED DESCRIPTION OF THE INVENTION

Reference will now be made in detail to the preferred embodiments of the present invention, examples of which are illustrated in the accompanying drawings.

When one note is reproduced by applying an envelope in a MIDI-based music file, the envelope after Note-Off should reduce and finally fall down to zero so as to reproduce the note in the most ideal manner. However, since it is difficult that a reproducing apparatus (e.g., a mobile terminal) having limited resources reproduces a note in this manner, the present invention includes an envelope analyzer and a Note-Off envelope processor, thereby making possible high quality reproduction of sound even when limited processor resources are used.

In an envelope for reproduction of a MIDI file, the envelope reduces as time elapses after Note-Off and the volume of a sound gradually diminishes and finally becomes zero. However, the envelope has a considerable size even while it approaches zero. When the envelop having this considerable size is limited without a particular consideration, non-continuous points are generated between a zero point and a point greater than the zero point, so that noises are heard to a human ear depending on cases.

The present invention minimizes generation of non-continuous points and noises by determining a point that limits the reproduction of a MIDI file as a point that can reduce damage of sound quality, and forcibly terminating the reproduction of the MIDI file at the determined reproduction limitation point when the MID file is reproduced.

### FIRST EMBODIMENT

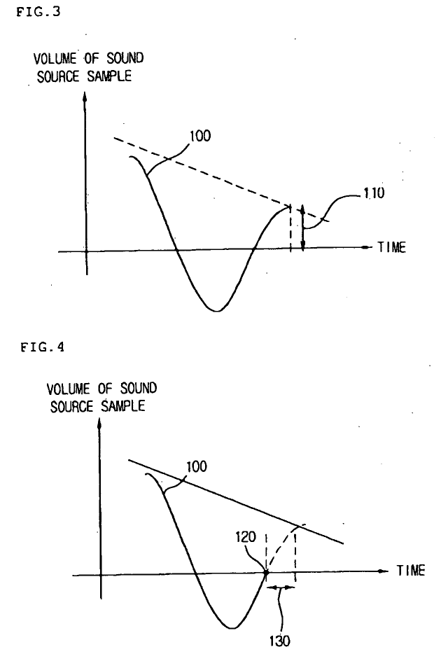

Referring to FIG. 3, a last value of a sound sample is greater than zero, and right after this, a point where the reproduction is limited appears and the value of an envelope 100 falls down to zero. Therefore, a non-continuous point of the envelope 100 is generated between a point greater than zero and a zero point, so that noises are generated. Such sound quality deterioration increases as a difference 110 between the volume of the last sound sample and zero increases.

FIG. 4 schematically illustrates a technique of moving a reproduction limitation point of a MIDI file to a point that can reduce sound quality deterioration on the basis of a zero crossing point searching. A plurality of notes and note reproduction times are extracted from a MIDI file, and a point where a sample value is close to zero is found out before a point where a non-continuous point is generated between a point greater than zero and a zero point. After that, the found point is set to a point 120 where the envelope 100 is limited after Note-Off. By doing so, it is possible to reduce noises generated when a MIDI file is reproduced by reducing a difference in the volume of a sound between the point 120 where the reproduction of the MIDI file is limited and the zero point.

Here, as a method for finding out a point where a sample value is close to zero, a method for finding out a zero crossing point and determining that point as the point 120 that limits the sample value right before the zero crossing point, can be used.

The method for finding out the zero crossing point may be the following method, in which: a case where sample values before non-continuous points between a point greater than zero and a zero point are generated are less than zero, are found; a case where a sample value whose next sample value is greater than zero is found among the sample values that correspond to the above case; a sample value less than zero is determined as a point 120 that limits reproduction of the sample, and the sample is not reproduced after that point 120 and the sample value is fixed to zero. By doing so, a sample value that is closest to zero among the sample values in the vicinity of the limitation point 120 is changed into zero, so that a difference between the sample value at the limitation point 120 and zero is reduced and noises are reduced when a MIDI file is reproduced.

### SECOND EMBODIMENT

FIG. 5 is a view of an apparatus for reproducing a MIDI file according to the second embodiment of the present invention.

Referring to FIG. 5, the apparatus includes: a MIDI parser 121 for extracting a plurality of notes and note reproduction times from the MIDI file; a MIDI sequencer 122 for outputting sound source samples according to the plurality of notes and note reproduction times extracted from the MIDI parser 121; a zero crossing point searching part 123 for searching a point where the volume of a sound source sample is close to zero; an envelope applying part 124 for applying the zero crossing point searched by the zero crossing point searching part 123 to an envelope; a wave table 126 for registering the sound source samples; and a frequency converter 125 for converting a frequency of a music file which will be outputted.

When a MIDI file is inputted, the MIDI parser 121 parses the MIDI file to extract a plurality of notes and note reproduction times contained therein. Here, the note reproduction times mean respective reproduction times of the respective notes. The MIDI file can contain a plurality of notes and note reproduction times. A note is information representing a sound. For example, the note represents information (e.g., Do, Re, and Mi) regarding a musical scale. Since the note is not a real sound, it should be reproduced into actual sound sources. A musical scale can include a range of 1-128. A MIDI file can be a musical piece consisting of a start and an end of one song. This musical piece can include numerous musical scales and time lengths of respective musical scales. Therefore, a MIDI file can contain information regarding notes that correspond to respective musical scales and the reproduction times of the respective notes. The note reproduction time means a reproduction time of each of the notes contained in the MIDI file and is information regarding the same length of a sound. For example, when the reproduction time of a note “Re” is ⅛ second, a sound source that corresponds to the note “Re” is reproduced for ⅛ second when it is reproduced.

The plurality of notes extracted from the MIDI parser 121 are inputted to the MIDI sequencer 122. The MIDI file inputted to the MIDI parser 121 can contain tens of notes through 128 notes regarding a musical scale. Therefore, the notes contained in the MIDI file cannot be reproduced using sound source samples registered in the wave table 126. Instead, the sound source samples registered in the wave table 126 are frequency-converted into sound source samples that correspond to notes contained in the MIDI file and reproduced.

The MIDI sequencer 122 that receives the respective reproduction times of respective notes from the MIDI parser 121 sequentially reads, from the wave table 126, sound source samples that correspond to respective notes according to the respective reproduction times of the respective notes and outputting the same, so that the reproduction of the MIDI file can be performed. However, when a note contained in the MIDI file is reproduced, the volume of a sound sample after Note-Off should reduce to be close zero so as to reproduce the note in the most ideal manner. For that purpose, the envelope value of a sound source sample after Note-Off is searched to capture a point where the envelope value approaches zero and this point should be applied as a limitation point 120. Otherwise, a non-continuous point where the envelope value rapidly reduces to zero is generated to have an adverse influence on sound quality. For that purpose, the zero crossing point searching part 123 captures the zero crossing point of the envelope. The zero crossing point captured through the zero crossing point searching part 123 is applied to the envelope as the limitation point 120 by the envelope applying part 124. Therefore, a noise of a sound source generated from the envelope is eliminated and a high quality sound can be secured even in the case where a sound is synthesized using limited processor resources.

### THIRD EMBODIMENT

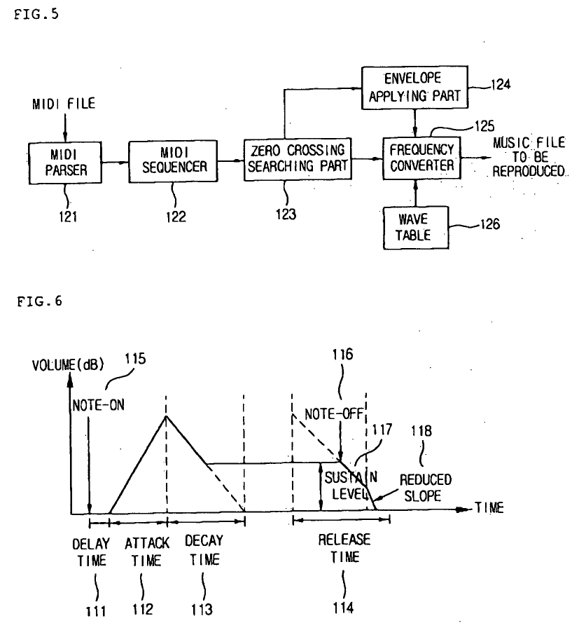

FIG. 6 is an exemplary view illustrating an envelope when a MIDI file is reproduced according to the present invention. FIG. 6 illustrates a method for reproducing a MIDI file on the basis of an envelope slope control. After Delay 111 starting from Note-On 115, there are timings such as Attack 112, Decay 113, Sustain 117, and Release 114. After Note-Off 116, a slope reduces. The envelope reduces and the volume of a sound diminishes and finally becomes zero as time elapses after Note-Off 116 in the envelope illustrated in FIG. 6. However, since it takes a considerable time until the envelope becomes zero, the envelope is limited to a predetermined time. Since the volume of a sound is greater than zero at a limitation point, a non-continuous point is generated between a point greater than zero and a zero point, so that noises are generated.

To solve this problem, the slope of the envelope is allowed to fall down without cutting for a predetermined period of time before the point where a non-continuous point between a point greater than zero and a zero point is generated, so that the envelope may reach a value close to zero at the point where the non-continuous point is generated. At this point, when a degree by which the slope falls down is uniformly applied to all the cases, sound quality may be distorted because the volume of a sound at the point at which the slope falls down and a time duration between the point at which the slope falls down and a limitation time are different depending on notes and a circumstance where notes are tied. Therefore, the present invention differently applies the degree by which the slope of the envelope falls down depending on these two factors.

First, as the volume of a sound at the point at which the slope falls down is large, the degree by which the slope falls down should be large. That is, the volume of the sound at the point at which the slope falls down is proportional to the degree by which slope falls down. Also, as the duration between the point at which the slope falls down and the limitation point is long, the degree by which slope falls down should be small. That is, the duration between the point at which the slope falls down and the limitation point is inversely proportional to the degree by which slope falls down. Above relationship is given by the following equation. Assuming that the volume of a sound at a point at which slope falls down is Vₛ, duration between the point at which the slope falls down and the limitation point is T_{d}, and a degree by which the slope falls down is Y_{d},
Y_{d}=C×Vₛ/T_{d},

where C is a proportional constant.

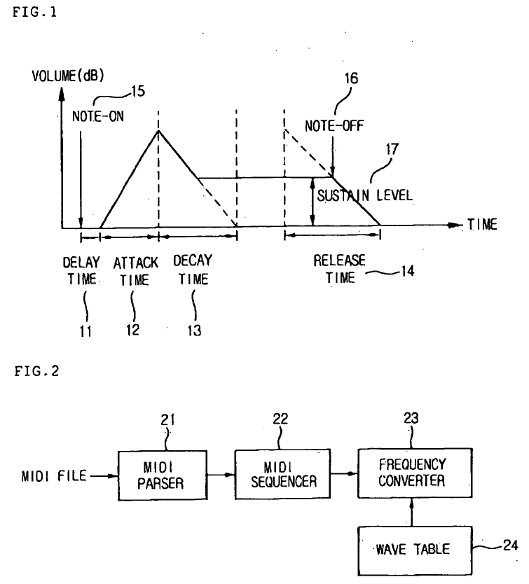

When the shape of the envelope illustrated in FIG. 6 is compared with that of the envelope of a related art illustrated in FIG. 1, the present invention applies a reduced slope to the last portion of Release Time 114 to allow the volume of a sound to fall down to zero within a limited time, thereby reducing noises when a MIDI file is reproduced.

### FOURTH EMBODIMENT

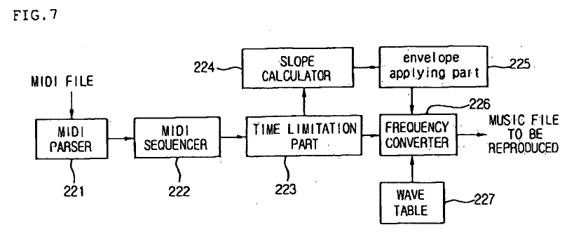

FIG. 7 is a view of an apparatus for reproducing a MIDI file according to the fourth embodiment of the present invention.

Referring to FIG. 7, the apparatus includes: a MIDI parser 221 for extracting a plurality of notes and note reproduction times from the MIDI file; a MIDI sequencer 222 for outputting sound source samples according to the plurality of notes and note reproduction times extracted from the MIDI parser 221; a time limitation part 223 for limiting a time consumed until the size of an envelope after Note-Off converges to zero; a slope calculator 224 for calculating the slope of an envelope according to the size of the envelope at the limited time of the time limitation part 223 and Note-Off 116; an envelope applying part 225 for applying the calculated slope to the envelope; a wave table 227 for registering the sound source samples; and a frequency converter 226 for converting the frequency of a music file which will be outputted.

When a MIDI file is inputted, the MIDI parser 221 parses the MIDI file to extract a plurality of notes and note reproduction times contained therein. Here, the note reproduction times mean respective reproduction times of the respective notes. The extracted notes are inputted to the MIDI sequencer 222.

The present invention reduces the slope of Note-Off of a sound source sample to minimize a use amount of a processor and allow a MIDI file to be reproduced in high quality. The MIDI sequencer 222 that receives the respective reproduction times of respective notes from the MIDI parser 221 sequentially reads, from the wave table 227, sound source samples that correspond to respective notes according to the respective reproduction times of the respective notes and outputting the same, so that the reproduction of the MIDI file can be performed.

When notes contained in a MIDI file are reproduced, Release Time 114 after Note-Off 116 should be maintained so as to allow a most ideal sound to be reproduced for each note. For that purpose, the slope of the envelope should be changed and applied depending on circumstance after the Note-Off 116. Otherwise, the Release Time 114 is lengthened and sound quality can be distorted. In the present invention, the time limitation part 223 controls a time T_{d} consumed until an envelope value becomes zero after the Note-Off 116. Also, the slope calculator 224 calculates the slope of an envelope using T_{d} and the volume Vₛ of a sound at the Note-Off 116 of an envelope. The slope of the calculated envelope is proportional to Vₛ and inversely proportional to T_{d}. The slope of the envelope calculated in this manner is applied to a sound source sample through the envelope applying part 225. That is, an envelope slope 118 is controlled on the basis of Y_{d}=C×Vₛ/T_{d}, so that the envelope reduces smoothly and stably without cutting and thus sound quality can improve.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for reproducing a MIDI file, the method comprising:
setting a point that limits reproduction of the MIDI file;
searching for a reproduction time of the MIDI file which will be reproduced; and
limiting a reproduction termination point by the searched reproduction time to the set reproduction limitation point.

2. The method according to claim 1, wherein the reproduction limitation point and the reproduction termination point are based on an envelope of a volume or a pitch.

3. The method according to claim 1, wherein a point where a sound sample value after Note-Off has a value closest to zero is selected as the reproduction limitation point.

4. The method according to claim 1, wherein the reproduction limitation point is set by controlling an envelope slope after Note-Off.

5. An apparatus for reproducing a MIDI file, the apparatus comprising:
an element for extracting notes and note reproduction times from the MIDI file;
an element for searching a point that limits reproduction after Note-Off on the basis of the extracted notes and note reproduction times; and
an element for terminating reproduction of a relevant note at the searched reproduction limitation point.

6. The apparatus according to claim 5, wherein the reproduction limitation point and a reproduction termination point are based on an envelope of a volume or a pitch.

7. The apparatus according to claim 5, wherein a point where a sound sample value after Note-Off has a value closest to zero is selected as the reproduction limitation point.

8. The apparatus according to claim 5, wherein the reproduction limitation point is set by controlling an envelope slope after Note-Off.

9. A method for reproducing a MIDI file, the method comprising:
extracting notes and note reproduction times from the MIDI file;
searching a point where envelope values of sound samples are close to zero after Note-Off on the basis of the extracted notes and note reproduction times; and
determining the searched point as a reproduction termination point of a relevant note.

10. The method according to claim 9, wherein the reproduction termination point is determined to be a sample value right before a zero crossing point of an envelope value.

11. The method according to claim 9, wherein all of sound sample values after the reproduction termination point are set to zero.

12. An apparatus for reproducing a MIDI file, the apparatus comprising:
an element for extracting notes and note reproduction times from the MIDI file;
an element for searching a point where envelope values of sound samples after Note-Off are close to zero on the basis of the extracted notes and note reproduction times;
an element for determining the searched point as a reproduction termination point of a relevant note; and
an element for applying the determined reproduction termination point to reproduce the relevant note.

13. The apparatus according to claim 12, wherein the reproduction termination point is determined on the basis of a zero crossing point searching.

14. A method for reproducing a MIDI file, the method comprising:
extracting notes and note reproduction times from the MIDI file;
calculating a slope of an envelope which will be applied after Note-Off on the basis of the extracted notes and note reproduction times; and
terminating reproduction of a relevant note by applying the calculated slope.

15. The method according to claim 14, wherein the slope of the envelope depends on a volume at a falling point.

16. The method according to claim 14, wherein the slope of the envelope depends on duration between a falling point and a termination point.

17. The method according to claim 14, wherein the slope of the envelope depends on both a volume at a falling point and duration between the falling point and a termination point.

18. The method according to claim 14, wherein a reproduction termination point is limited to a time where an envelope value after the Note-Off becomes zero, and the slope is calculated as a slope which will be applied up to the limitation point.

19. An apparatus for reproducing a MIDI file, the apparatus comprising:
an element for extracting notes and note reproduction times from the MIDI file;
an element for calculating a slope of an envelope which will be applied after Note-Off on the basis of the extracted notes and note reproduction times; and
an element for applying the calculated slope and applying a reproduction termination point of a relevant note to the envelope to reproduce the relevant note.

20. The apparatus according to claim 19, wherein the slope of the envelope depends on a volume at a falling point and/or duration between a falling point and a termination point.
